(19) United States
(12) Patent Application Publication
(10) Pub. No.: US 2005/0081251 A1
(43) Pub. Date: Apr. 14, 2005

(54) Method and apparatus for providing interactive multimedia and high definition video

(76) Inventors: Bradley K. Walker, Lincoln, NE (US); John D. Turnipseed, Lincoln, NE (US); Daniel J. Castagnoli, Lincoln, NE (US); Tanner Tuttle, Lincoln, NE (US)

Correspondence Address: BLACKWELL SANDERS PEPER MARTIN LLP, 4801 Main Street, Suite 1000, KANSAS CITY, MO, 64112, US

(21) Appl. No.: 10/684,100

(22) Filed: Oct. 10, 2003

(51) Int. Cl. H04N 7/173; H04N 11/04; H04N 11/02; H04N 7/12; H04N 7/16

(52) U.S. Cl. 725/135; 725/86; 725/109; 725/110; 348/437.1

(57) ABSTRACT

The present invention is directed to a system and method for use in a computing environment to provide high definition (HD) video content as part of a multimedia experience over computing networks such as Internet Protocol (IP) networks. The present invention provides an interactive entertainment system where HD video is provided in a personal computing environment through novel compression techniques and optimization for the rendering hardware. Further, the HD video is embedded into other multimedia offerings to allowing unprecedented interaction by end users.

### BACKGROUND OF THE INVENTION

1. Field of Invention

The present invention relates generally to computing environments. More particularly, the invention is directed to a system and method for providing interactive high definition video as part of an interactive multimedia system, over a computing network.

2. Background Art

Visual stimulation continues to be one of the key methods of conveying information to an audience. Coupling audience interaction with such visual stimulation further conveys information and can provide entertainment. An integral part of today's society is the thirst for information that is quick, easy to access and accurate. This quest extends beyond just the textual information and graphical images that can be delivered by computing systems. There is a demand for lifelike images and realism that is only possible through high quality video images.

High quality video images provide a very distinct level of clarity, crispness and realism that far surpasses traditional video images. Such is the nature of high definition video. High definition video comprises a lot of detail and data as such, it requires a medium with ample storage capability, such as a Digital Versatile Disk (DVD), for storing or transporting its content. The video industry has been revolutionized DVD. DVD was the first union of emerging technologies, bringing together computer consumer electronics and entertainment. There was a reshaping of the world of entertainment as a result of the multi-purpose technology that offered studio quality video and audio combined with interactivity. DVD has enabled the presentation and delivery of high definition (HD) video to computing systems. However, such delivery is currently only made possible by the transfer of removable media from the recording device to the computing system. Traditional transfer of HD content involves creating footage on a medium such as a DVD, DVD-RAM drive, etc. that can be physically moved to the playback device. At the playback device, the content is rendered through a digital video decoder card and then displayed onto a plasma or other screen that can support the display level.

HD video format specifies the data recording of MPEG 2 compressed high-definition signals based on a digital video format. Digital video format is internationally accepted as a digital VCR format i.e. D-VHS. Video signals are compressed by MPEG 2 encoding in an inter-frame compression for storage on D-VHS. MPEG-2 is a set of technology specifications for the compression, decompression, processing, and coded representations of video and audio. It was defined by the MPEG (Moving Picture Experts Group) committee, the working group within the International Organization for Standardization (ISO) that specified the popular MPEG-1 standard and the new MPEG-4 standard. MPEG-2 was approved in 1994 and is the basis for such products as Digital Television set top boxes and DVD.

MPEG-1 and MPEG-2 provide interoperable ways of representing audiovisual content, commonly used on digital media and on the air. DVD enables multiple format viewing such as the 4:3 TV screen format, the 16:0 HDTV screen format and the 20:9 letterbox format. When these viewing features are combined with Dolby channel surround sound, user experience is elevated to a level that rivals that of a theater. However, such user experience has not been available in the PC network environment. The ability to incorporate high definition video into the personal computing world has been limited by certain physical constraints.

Ordinarily, there is a vast amount of data involved with standard video images. The ability to transmit such data over PC networks is hampered by the bandwidth of the network and the desired transmission rate that is necessary for acceptable user experience. This dilemma is further magnified when considering high definition video. For example, a two-hour MPEG-2 video with a four megabit per section (Mbps) bandwidth requirement is about 3.6 gigabytes in size. Transfer of such data quantities would take an inordinate amount of time, which is generally intolerable to users. HD media require a high transmission bandwidth. For example, a video resolution of 1920×1080 pixels encoded via MPEG-2 results in a data rate of 19.4 Mbps. The low bandwidth of data communication networks such as the Internet precludes the incorporation of such video into multimedia productions on PC networks. HD video has thus not been offered in an interactive forum. Thus far, HD video is available via satellite, air wave distribution, removable media or over cable TV networks. The distribution in these models is in linear form and without interactivity.

Accordingly, there exists a need for an improved method and system to provide interactive HD content to individuals and address the shortcomings described above. High impact images along with a variety of options and interaction levels should be available for delivery to personal computing systems over computing networks. High definition content should be deliverable for rendering and interaction by end-users for the purpose of entertainment or other informational needs. Furthermore, there is a need for incorporating HD content with other multimedia content to provide enhanced user experiences.

### BRIEF SUMMARY OF INVENTION

The present invention is directed to a system and method for use in a computing environment to provide high definition video content as part of a multimedia experience over computing networks such as Internet Protocol (IP) networks.

Multimedia or continuous play media can be defined as containing a stream of textual or visual content presented so as to form a perceived continuity when presented to an observer. Multimedia may further contain audio content delivered with a perceived continuity. Even further, multimedia may contain any other content streams including closed caption support or dialogue presentations in one or more languages.

In the preferred embodiment of the present invention, an interactive entertainment system is implemented. HD video is provided in a personal computing environment over IP, through novel compression techniques and optimization for the rendering hardware. Further, the HD video is embedded into other multimedia offerings to allowing unprecedented interaction by end users.

The physical data rate limitations of the internet and other similar communications medium are overcome by the present invention, thus allowing HD quality files to be transferred over IP networks to PCs for display. Further, composites of HD quality information are provided for navigation by an end user. Such composites include thumbnails, traditional browser, and HD images and video.

The present invention provides personalized and scalable high definition content to end-users. In a further aspect, the presented content is customizable and can be remotely monitored by an administrator.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1A is a network architecture diagram of a typical client-server environment for implementing the present invention;

FIG. 1B is a block diagram illustrating the components and function of the network nodes of FIG. 1A;

FIG. 1C is a block diagram of an exemplary operating environment for practicing the present invention;

FIG. 2 is an illustrative screen display diagram of a client environment for practicing the present invention;

FIG. 3A is a screen shot display of a user interface in the skybox system along with options that may be presented to a user in an embodiment of the present invention;

FIG. 3B is a screen shot display of a user interface in the skybox system depicting the component windows and display associated with the video highlights presentation implemented in the present invention;

FIG. 3C is a screen shot display of a user interface in the skybox system depicting the component windows and display associated with the high definition image presentation implemented in the present invention;

FIG. 4 is a flow diagram representative of the relationship and interaction of the various components in the present invention; and

FIG. 5 is a table of Cleaner settings utilized in the preferred embodiment of the present invention.

### DETAILED DESCRIPTION OF INVENTION

The present invention is directed to a system and method for providing interactive high definition content, over an IP network as part of an interactive multimedia system.

In that regard, the present invention may be described in the general context of computer-executable instructions, such as program modules, being executed by a computer. Generally, program modules include routines, programs, objects, components, data structures, etc. that perform particular tasks or implement particular abstract data types. Those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. When operating in a distributed computing environment, program modules may be located in both local and remote computer storage media including other memory storage devices. Additionally, various functions that will be described herein may be implemented by modules that exist wholly or partially on a client system or a server.

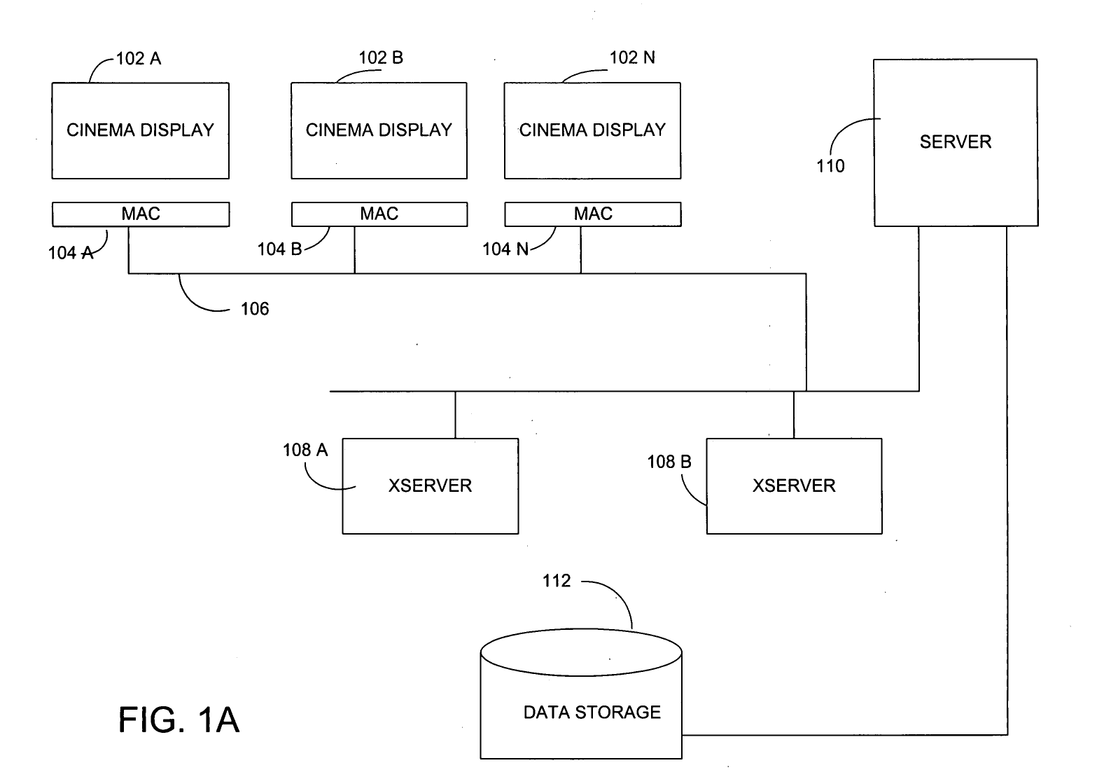

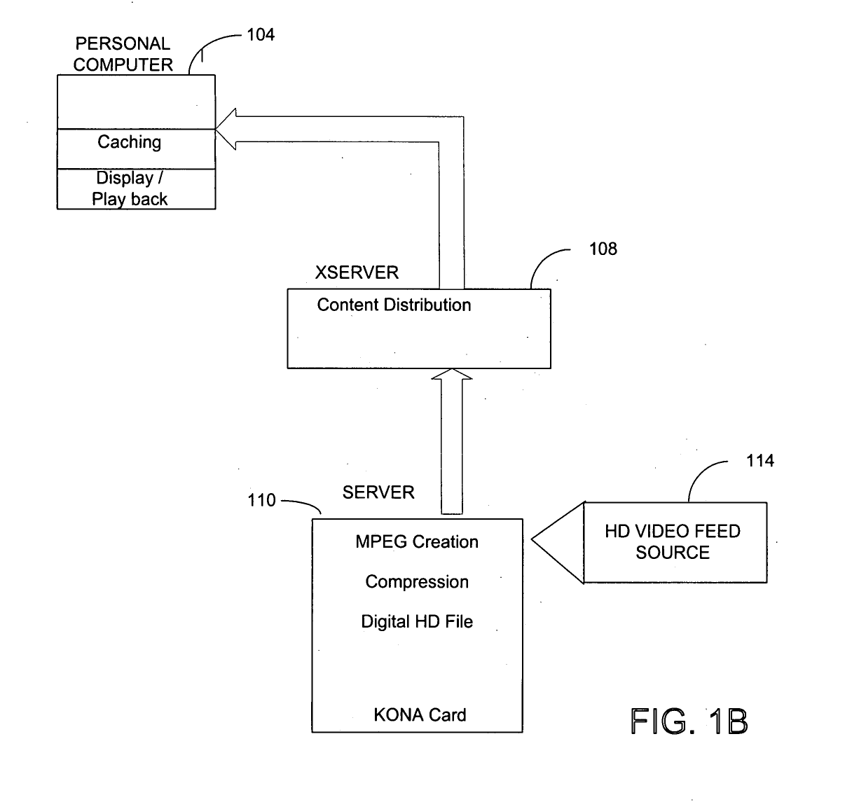

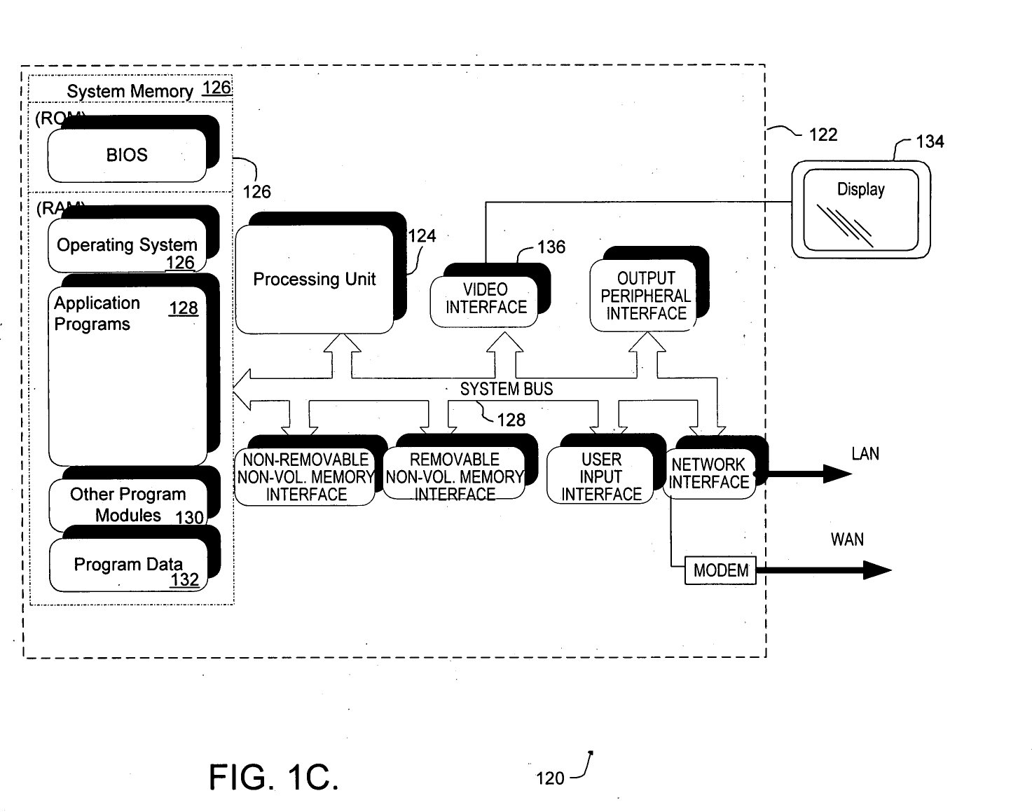

According to the embodiment(s) of the present invention, various views are illustrated in FIG. 1-5, wherein like reference numerals are being used consistently throughout to refer to like and corresponding parts of the invention for all of the various views and figures of the drawing. Also, please note that the first digit(s) of the reference number for a given item or part of the invention should correspond to the FIG. number in which the item or part is first identified.

In the preferred embodiment of the present invention, an interactive multimedia, high definition video, and personalized experience is implemented. This embodiment of the user experience is referenced herein as a Skybox system. It should be understood that the term skybox system is utilized to facilitate the discussion and is in no way intended to limit the present invention to any particular version or feature of the named implementation.

The skybox system is a high definition based personal computing application that combines high definition interactive performance and rich video/audio capabilities with the internet, thus providing unprecedented options and possibilities for user entertainment and experience. The described embodiment of the invention is directed to fan experience as it relates to a hockey team and the team's arena. At the center of the experience is a display and customized interface. Suites within the arena are equipped with widescreen format Cinema High Definition liquid crystal displays that support 1920×1200 pixel resolution or over 2.3 million digital pixels. A personal computing device in each suite drives the system, while the backend content is managed and delivered through a dynamic media database(s). The database(s) run on one or more content distribution servers and the high definition content is provided by an external provider.

Having briefly provided an overview of the present invention, the preferred embodiment of the invention will be discussed with reference to FIGS. 1-5. An exemplary operating environment and architecture for the present invention is first described below.

The details of the invention and various embodiments can be better understood by referring to the figures of the drawing. Referring to FIG. 1, a functional diagram of a typical client-server network environment 100 implementing a graphical user interface is shown. The present invention should not be interpreted as having any dependency or requirement relating to any one or combination of components illustrated in the exemplary network environment 100.

As shown, the network environment 100 comprises component nodes suitable for practicing the present invention. A network 106 can include a LAN, WAN, Internet, wireless or other communication scheme for computing devices. In the preferred embodiment of the present invention, the network 106 provides continuity between nodes. The nodes of the network 106 include a number of personal computing (PC) devices 104a, 104b and 104n, collectively referenced as PC 104, one or more XServers 108a, 108b collectively referenced as XServer 108 and a Server 110. Each node may be coupled to the network 106 via network interface modules such as a network interface card (NIC).

The PC 104 receives images from one or more streaming sources. Utilizing a customized shell, the PC 104 renders images onto a cinema display 102a, b and n. Cinema display 102a, b and n are preferably high resolution 1080i specification displays. In other words, cinema display 102a, b or n should be capable of 1920×1080 interlace (1080i) display to support high definition live action or sport events. The PC 104 may be a Dell, Compaq, IBM or any compatible PC product. It could also be, as implemented in an embodiment of the present invention, a Macintosh computer having 512 MB of RAM, a processor speed of 800 MHZ, a fast bus and hard drive, with a 64 MB video graphics card. Importantly, the PC 104 must provide support for playback mechanisms and data rates that are commensurate with high definition video modes.

The Xservers 108 provide content distribution to the one or more PCs 104. As shown in FIG. 1B, streaming video is distributed from the Xservers 108 via the network to the PC 104. PC 104 provides caching of the streamed information, implements computer programs and algorithms to facilitate playback and display of the streamed video. Xservers 108 utilize Quicktime streaming software from Apple Computers Inc. to provide video distribution.

The Server 110, as shown in FIG. 1, is connected directly or remotely to a data storage 112, which may hold digital files prior to transmission to content distribution Xservers 108. Returning to FIG. 1B, as illustrated, the Server 110 provides several other functions beyond basic data storage. The Server 110 receives and processes HD feed for subsequent distribution. The HD feed is edited, finished and compressed on the server 110. However, it should be noted that such functions may be performed on a machine other than the server such as an editing suite or an intermediary step. A program such as Final Cut pro, also from Apple Computers Inc, is utilized for the editing and finishing tasks. The HD feed footage is edited into short Quick Time clips, which can then be provided for distribution by the Xservers 108. While one server is shown, it would be understood and appreciated that there could be multiple servers. Furthermore, the function performed on any one server can be performed through collaboration on one or more other systems to achieve the same result. Importantly, the system of the present invention is scalable at any of the levels described herein. In other words the system is able to accommodate multiple PCs 104, Xservers 108 or Servers 110 as needed by the intended environment.

HD feed to the server 110 may consist of HD Video and supporting data, which are provided from a feed source 114. Feed source 114 can include a HD acquiring production unit, such as HDnet. HDnet can record events onto a DHVS tape from which the HD feed can be provided to the server 110. Alternatively, video feed may be provided via a KONA card that is installed in the server 110 directly from HDnet. A KONA card or other HD digitizing card must be used with either live or stored HD. Essentially, the HD content must be ripped from the feed, which is either live or from tape, and fed into a computer with an HD card.

As illustrated in FIG. 1B, MPEG files of the HD feed may be created on server 110 utilizing a compression algorithm that has been optimized for transmission throughput to the PC 104 via the distribution Xservers 108.

Referring to FIG. 1C, an example of a suitable computing system environment 120 in which the invention may be implemented is illustrated. The computing system environment 120 is only one example of a suitable computing environment and is not intended to suggest any limitation as to the scope of use or functionality of the invention.

Exemplary Operating Environment

FIG. 1C illustrates an example of a suitable computing system environment 120 on which the invention may be implemented. The computing system environment 120 is only one example of a suitable computing environment and is not intended to suggest any limitation as to the scope of use or functionality of the invention. Neither should the computing environment 120 be interpreted as having any dependency or requirement relating to any one or combination of components illustrated in the exemplary operating environment 120.

With reference to FIG. 1C, an exemplary system 120 for implementing the invention includes a general purpose computing device in the form of a computer 122 including a processing unit 120, a system memory, and a system bus that couples various system components including the system memory to the processing unit. Importantly, the variant of the computer 122 utilized as the client PC 104 must support a playback mechanism and data rates suitable for high end image rendering.

Computer 122 typically includes a variety of computer readable media, which may comprise computer storage media and communication media. The system memory includes computer storage media in the form of volatile and/or nonvolatile memory such as read only memory (ROM) and random access memory (RAM). A basic input/output system (BIOS), containing the basic routines that help to transfer information between elements within computer 122, such as during start-up, is typically stored in ROM. RAM typically contains data and/or program modules that are immediately accessible to and/or presently being operated on by processing unit 124. For illustrative purposes, FIG. 1C depicts operating system 126, application programs 128, other program modules 130, and program data 132.

The computer 122 may also include other removable/nonremovable, volatile/nonvolatile computer storage media. Such removable/non-removable, volatile/nonvolatile media may include a hard disk drive, a magnetic disk drive, an optical disk drive, a CD ROM or other optical media. Other removable/nonremovable, volatile/nonvolatile computer storage media that can be utilized include, but are not limited to, magnetic tape cassettes, flash memory cards, digital versatile disks, digital video tape, solid state RAM, solid state ROM, and the like.

The drives and their associated computer storage media discussed above and illustrated in FIG. 1C, provide storage of computer readable instructions, data structures, program modules and other data for the computer 122. A user may enter commands and information into the computer 122 through input devices such as a keyboard, pointing device or scripting interface. Other input devices may include a microphone, joystick, game pad, satellite dish, scanner, or the like. These and other input devices may be connected by other interface and bus structures, such as a parallel port, game port or a universal serial bus (USB). A monitor 134 or other type of display device is also connected to the system bus 128 via an interface, such as a video interface 136. In addition to the monitor, computers may also include other peripheral output devices such as speakers, and printers, which may be connected through a output peripheral interface.

The computer 122 in the present invention will operate in a networked environment using logical connections to one or more remote computers, such as a remote computer. The remote computer may be a personal computer, and typically includes many or all of the elements described above relative to the computer 122. The logical connections depicted in FIG. 1 include a local area network (LAN) and a wide area network (WAN), but may also include other networks.

When used in a LAN networking environment, the computer 122 is connected to the LAN through a network interface or adapter. When used in a WAN networking environment, the computer 122 typically includes a modem or other means for establishing communications over the WAN, such as the Internet. In a networked environment, program modules depicted relative to the computer 122, or portions thereof, may be stored in the remote memory storage device. It will be appreciated that the network connections shown are exemplary and other means of establishing a communications link between the computers may be used.

Although many, other internal components of the computer 122 are not discussed or shown, those of ordinary skill in the art will appreciate that such components and the interconnection are well known. Accordingly, additional details concerning the internal construction of the computer 122 need not be disclosed in connection with the present invention.

User Interface and Interaction

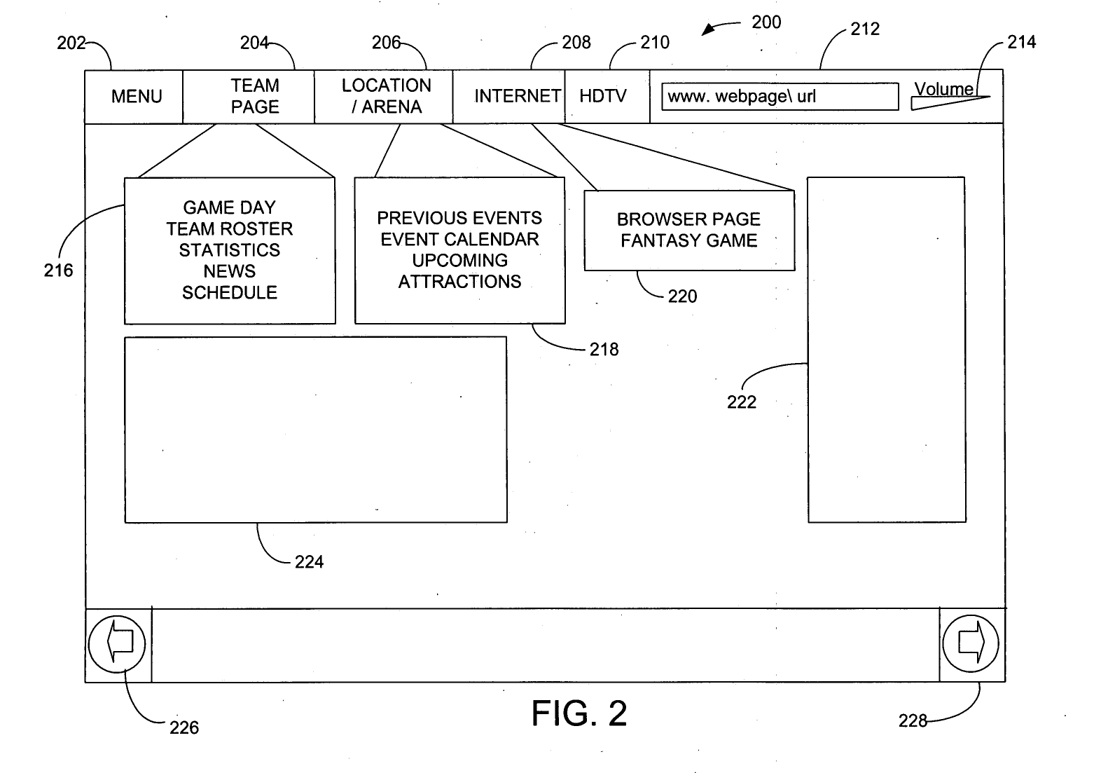

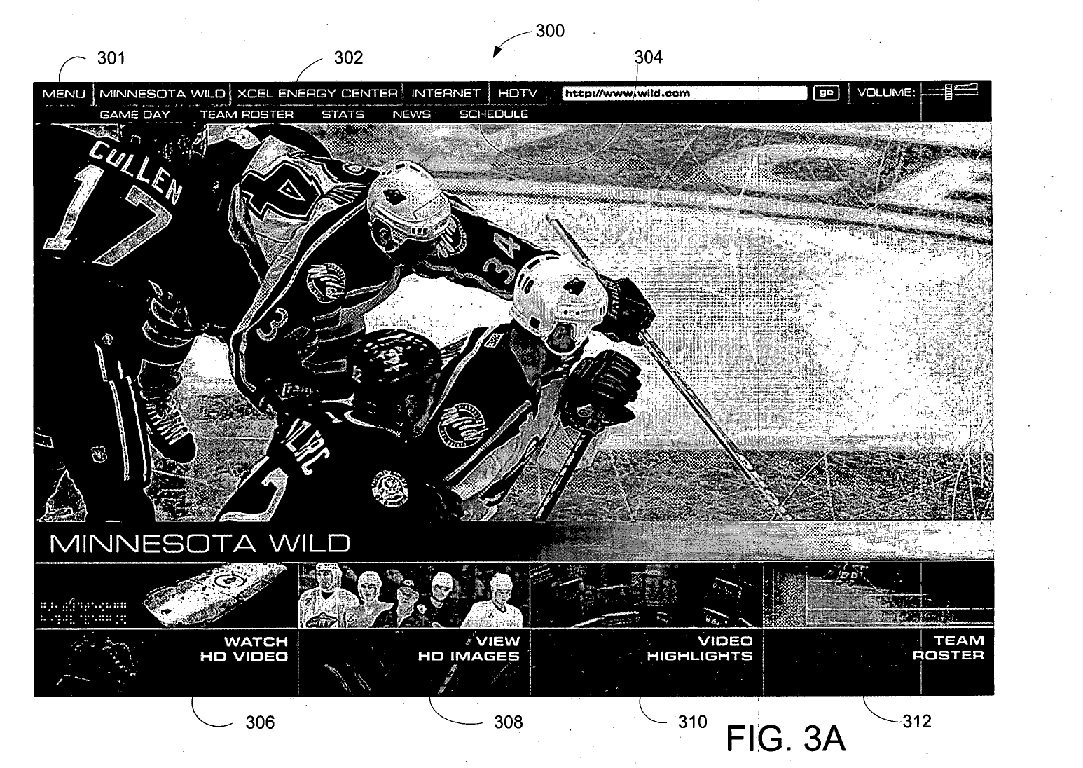

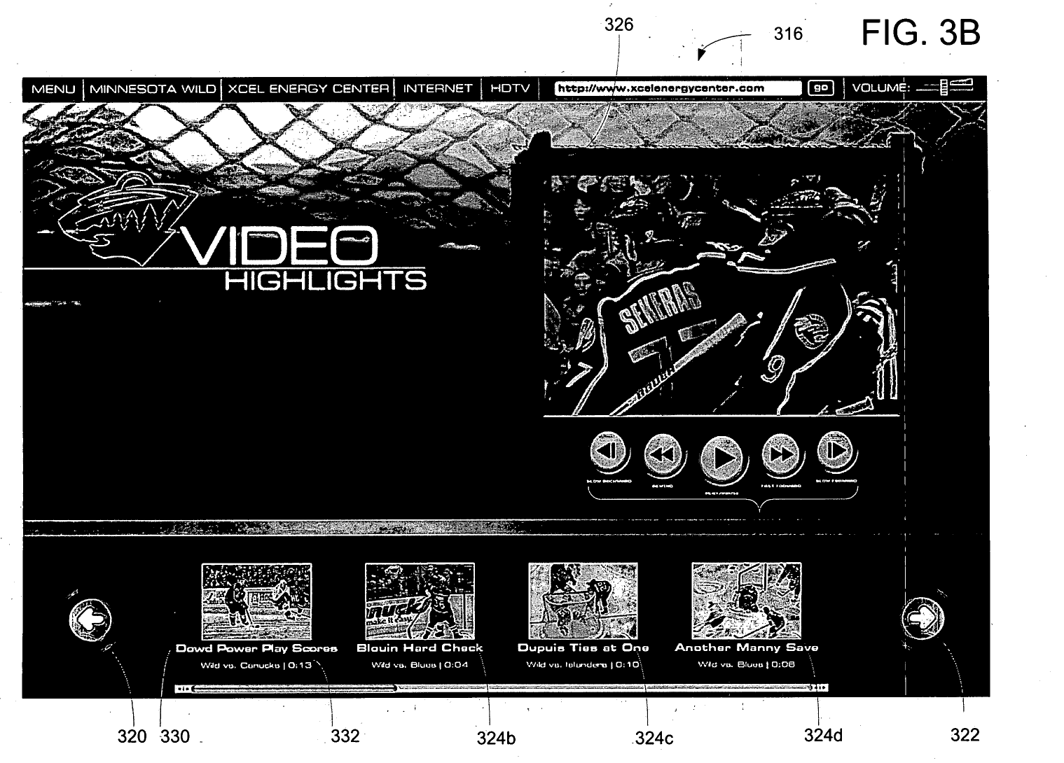

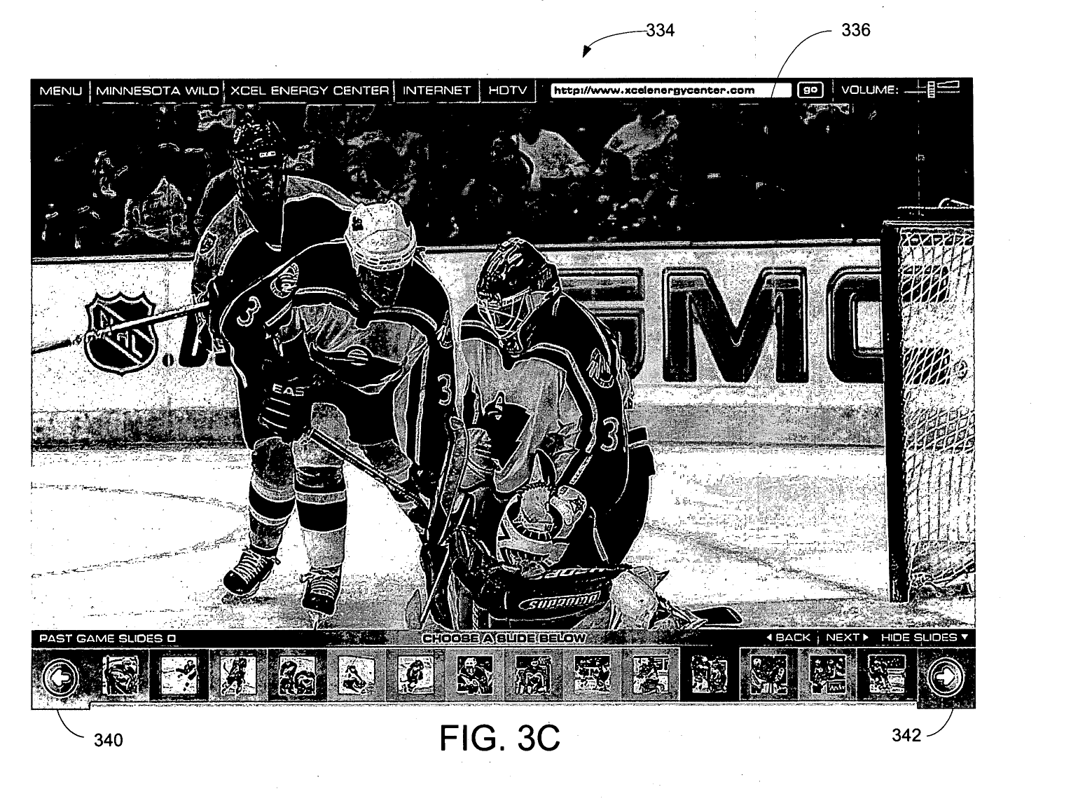

Having described the network and operating environment and introducing the process of the present invention, the user presentation and interactive features will be discussed next with reference to FIGS. 2, 3A-3C. In particular, the presentation and user interaction will be described in reference to a particular embodiment of the present invention. The subject embodiment is directed to delivery of high-resolution still images and HD video to guests in a sports arena for added entertainment. This entertainment system provides interactive multimedia, High Definition Video and personalized fan experience.

Turning initially to user presentation, an illustration of a user interface display screen of the present invention depicting some of the options and combination of multimedia that are available to a user is shown in FIG. 2. Web content, video content, music content, and other site related content are combined for presentation to a user in a single multimedia experience. The present invention enables branding of the various screens that are presented to end user on a case by case basis. In other words, the screens seen at one location i.e. the screen theme, of the sports arena need not be the same at every location. Even further, personalized messages can be presented at different screen display systems. The system can be customized by an administrator to suit multiple locations and areas within a venue. The administrator may enter variables that can specify a location by adding attributes to the sever files that controls each client computer. These variables such as name, favorites, logo etc, are passed in XML to the client and the client display software interprets the XML definition and composites these media items with the HD content. The HD content is also defined by the XML. As shown in FIG. 2, a series of navigation Tabs provide quick access to a variety of screen displays, informational items, data and choices that are available to the user, along with any site branding information.

For example, Menu Tab 202, as suggested by the title, provides access to the main introduction screen of the system and also provides a selection of options to the user for further navigating through the system.

Team Page Tab 204 presents the user with options that enable drill down to a variety of other data and media pertaining to the team. The presented media is available in standard and HD Video as well as static images. An example of the available information from this Tab are shown and collectively referenced as Option 216. The Option 216 includes game day information, team roster, team statistics, individual player statistics, news items and schedules.

The Location/Arena Tab 206 provides access to a display of information about the site of the events. In the described embodiment, the site is the Xcel Energy Center in St. Paul Minn. In other words, information about other events at the arena, sports complex, conference/civic center, stadium etc. is provided for convenient access by a user. For example, video of concerts that were previously held at the arena may be accessed and displayed. Similarly, dates and schedules for future events may also be displayed. Clips or other advertisements for upcoming attractions may also be displayed for selection and further interaction by the user. Such selections are illustrated by the Option List 218.

An Internet Browser Tab 208 provides access to a standard browser page or additionally to other pages such as, a page to allow the user to engage in a fantasy game, as shown in Options list 220. In conjunction with the Internet Browser Tab 208, there is a Text Entry Area 212. The Text Entry Area 212 allows a user to type in or view URLs that correspond to the page displayed by the browser. Also included on the display is a Volume Control 214. Pair of navigation icons 226, 228 is provided to enable a user to cursor through displayed video, text or other selections that are presented on the display 200. Display information may be presented to the user in such a way that the entire display region 230 is utilized. Conversely, information may be presented in multiple windows 224, 222. To further illustrate and explain the present invention, exemplary screen shots of the preferred embodiment of the present invention are provided in FIGS. 3A-3C. The screens illustrate the views, and choices available to a user, and provide a sense of the user experience.

Referring initially to FIG. 3A, a Screen Shot Display 300, which is based on a user's selection of a particular team page is shown. In this instance the user has selected “Minnesota Wild” Option 302 from the available selections in the navigation bar 301. A Sub-navigation bar 304 and a Picture 314 are displayed along with self-explanatory titled User Selectable Options 306, 308, 310 and 312. Each of the User Selectable Options 306, 308, 310 and 312 result in a change in the display and provide relevant video, images or text information. For example, when a user selects the Video Highlights Option 310, the Screen Shot 316 of FIG. 3B is displayed.

The screen shot 316 depicts an image of a monitor screen having playback controls 328. Using the playback controls 328, a user may navigate through a sequence of video highlights associated with an event selected from a group displayed at the lower portion of the display 316. In accordance with the user metaphor previously described, navigation arrows 320, 322 allow a user to cursor through the available collection of events, which are displayed at the lower portion of the display 316. As illustrated, each event 324a, 324b, and 324d is identified by a descriptive title 330 and a corresponding video length 332.

Referring to FIG. 3A, selection of “Watch HD Image” Option 308 would result in the screen shot 334 of FIG. 3C. As shown in FIG. 3C, a high definition image fills a display area 336 and HD thumbnails 338 of other available HD images are displayed across the bottom of the screen. Again, scroll arrows 340, 342 allow a user to scroll through additional thumbnails 338.

The thumbnails 338 provide both navigation and selection. Furthermore, the thumbnails 338 are database driven and have associated with them other descriptive information such as a textual description, event, date, etc. When a thumbnail 38 is selected, the associated HD image is requested from the Xservers 108.

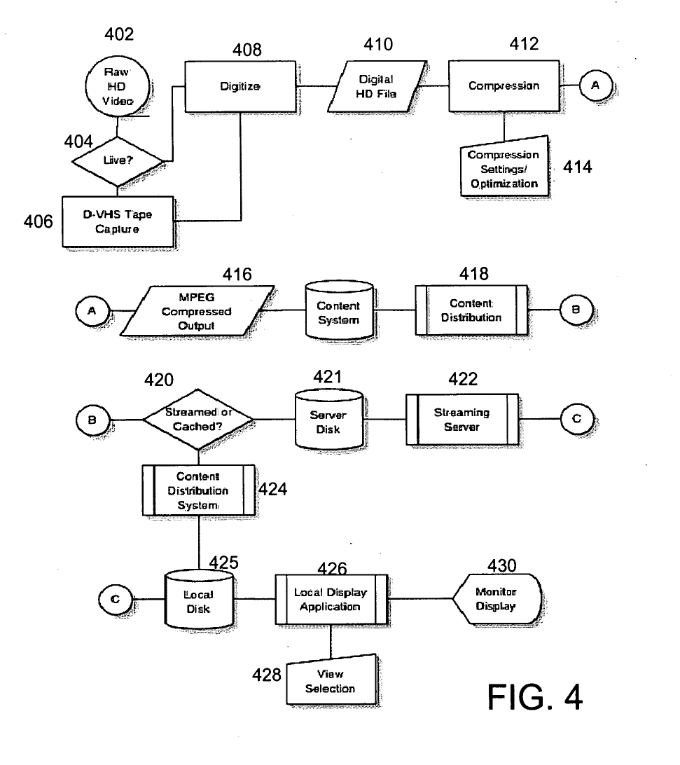

Having described the architecture, and screen interface of the present invention, turn next to the process for facilitating and providing the described features and benefits. The process of the present invention will be described with reference to FIG. 4.

Referring to FIG. 4, a flow diagram of the present invention is illustrated and generally referenced as diagram 400. As shown, the process of the preferred embodiment of the present invention begins with the production of high definition (HD) video images, at step 402. As previously explained, such production may come from a third party such as, Hdnet or may come from an HD camera device such as the AG-HDC27V camera from Panasonic Inc. Next, a determination is made to ascertain if the HD images are a live stream or exist on a Digital VHS tape, at step 404. If the HD images are provided on a Digital VHS tape, the content must first be digitized, at step 406. The digitization process is beyond the scope of the present invention and thus will not be discussed in any detail. The digitized images are then passed via a capture card such as the KONA card from AJA and Black Magic Design, to a final cut editing station, at step 408. The capture card provides full featured nonlinear editing. Conversely, live HD streams are stored and forwarded either in real time or post-production via the capture card in a digital format to the final cut editing station, at step 408. Irrespective of the source of the images, digital high definition files of the images are stored on the hard drive of the editing station at step 410.

Once the data is available on the final cut editing station, compression and creation of files suitable for transmission and viewing at client stations ensues. Prior to the compression, the HD images are cut and edited to reduce the size of the images. The cutting and editing are performed on the data at step 411. In effect, the cutting and editing involves the removal of the top eighty-eight pixels from the top of a native HD image i.e. the images end up being 1920×904 rather than 1920×1080.

At step 412, compression and frame rate determinations are performed on the data. In the preferred embodiment of the present invention a compression program from third party vendor—Cleaner from Discrete (www.discrete.com) was utilized. As would be appreciated by those skilled in the art, other similar products could also be utilized for compression without departing from the scope of the present invention.

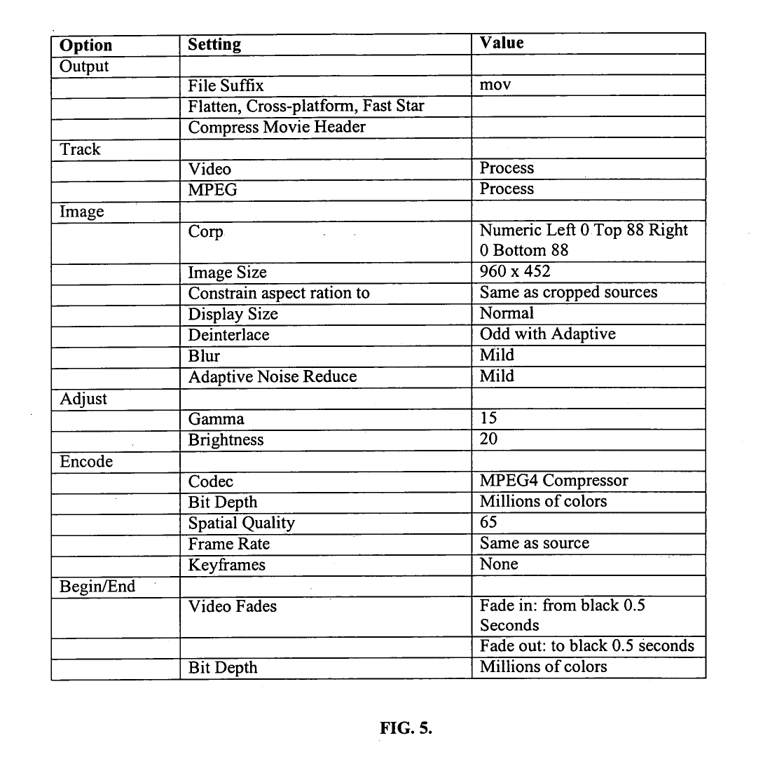

A critical component of the compression process of step 412, is the optimization that is provided by the present invention. The present invention identifies and provides optimal compression rates through defining various parameters and variables that are utilized by the algorithms of the Media cleaner program, at step 414. As would be understood by one skilled in the art, parameters and variables pertaining to frame rate, dimensions, quality level, CODEC, playback rate, download size, color number, etc. are critical to the ability to accomplish effective distribution and rendering of HD video. The correct combination of these and other similar parameters, which are provided in the table of FIG. 5, enable the present invention to overcome the size and bandwidth limitations discussed earlier in the background section.

A further critical component of the compression step 412 is that the HD movie or footage is compressed to half its number of pixels, while retaining enough quality. Upon playback at the client node 104, the movie is then doubled and playback occurs with less distortion than is traditionally available.

Following the compression, cleaning and optimization process, MPEG4 files are created at step 416, for upload to a content distribution system, at step 418. In the embodiment of the present invention, the content distribution system is the Xserver 108 shown and discussed earlier with reference to FIGS. 1A and 1B. The content distribution servers 108a, 108b contain both the HD data and application programs that enable a feed to the client PC systems 104a, 104b, . . . 104n.

The files may then be streamed or cached, at step 420. Information may be streamed to the server disk 421 and then provided to the system via a streaming server at step 422. Conversely, the files may be cached via a content distribution system at setp 424.

At each of the client systems 104, referring back to FIG. 4, there is a coordinated update of content and the high definition data is cached on the local disk, at step 425. A user selects an image or video to view at step 426. Local display application 426 renders the HD images on the monitor display 102 of FIG. 1A, at step 430. The rendered images are displayed according to any standard specification for HD display. User interaction and selections of the displayed images further dictate the actions and images that are subsequently displayed.

The system and method of the present invention provides the ability for a user to fully interact with a multimedia system that integrates HD content with standard video, Internet content and textual information. All of which is delivered over an IP network. The novel compression and optimization method of the present invention overcomes the limitations related to HD content size and HD content transmission over a limited bandwidth network. Further still, the present invention, using composite thumbnails of HD images for navigation and the customized CODEC and playback method, provides unprecedented interactive HD multimedia user experience.

The various features and screen examples shown and discussed above illustrate the novel features of the customer care system of the present invention. A user of the present invention may choose any of the above features or an equivalent thereof, depending upon the desired application. In this regard, it is recognized that various forms of the subject systems could be utilized without departing from the spirit and scope of the present invention.

As is evident from the foregoing description, certain aspects of the present invention are not limited by the particular details of the examples illustrated herein. It is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

1. A system for providing one or more interactive high definition video images over a network comprising:
a high resolution display device;
a personal computing device;
a content distribution device; and
a cut and editing station;
wherein said cut and editing station receives and processes high definition content to provide digital high definition files for transfer to said content distribution device;
wherein said content distribution device receives said digital high definition files, compresses and either streams or forwards, through IP-based file transfer methods, said digital high definition files as high definition video for distribution to said personal computing device;
wherein said personal computing device displays said high definition video on said high resolution display device;
wherein said personal computing device, said content distribution device and said cut and editing station are connected to the network.

2. A system as recited in claim 1, wherein distribution of said high definition video from said distribution device can occur either on demand by said personal computing device or in advance of a request through an automated distribution process.

3. A system as recited in claim 1, wherein the network is an Internet protocol network.

4. A system as recited in claim 1, wherein said personal computing device is an apple power book computer.

5. A system as recited in claim 1, wherein said high resolution display device is a liquid crystal display that supports 1920 by 1200 pixel resolution.

6. A method for providing an interactive multimedia experience including one or more high definition videos on a personal computing device, comprising:
receiving a high definition video feed;
editing and compressing said high definition video feed for distribution; and
streaming or sending said high definition video to the personal computing device over a data network for the interactive multimedia experience on a high definition display.

7. A method as recited in claim 6 further comprising, playback of said high definition videos in response to user selections on said personal computing device.

8. A method as recited in claim 7 further comprising, providing standard video content with the interactive high definition video media.

9. A method as recited in claim 8 further comprising, providing Internet content with the interactive high definition video media.

10. A method in a computing network environment for providing high definition content on a networked personal computing device, comprising:
digitizing a high definition feed;
providing one or more digital high definition files from said digitized high definition feed;
optimizing the compression of said one or more digital high definition files;
creating one or more MPEG files from said compressed digital high definition files;
transferring said one or more MPEG files to a content distribution system, via the computing network; and
receiving on the networked personal computing device said one or more MPEG files for display on a high resolution display.

11. A method as recited in claim 10 wherein providing said high definition content is in response to a user selection on the networked personal computing device.

12. A method as recited in claim 10 further comprising providing standard video content with the high definition content.

13. A method as recited in claim 12 further comprising providing Internet content with the high definition content.

14. A method as recited in claim 11, wherein said user selection is a thumbnail image of said high definition content.

15. A method in a computing network environment for providing a high definition content on a networked personal computing device, comprising:
receiving a high definition content feed;
optimizing compression of said high definition content feed for the networked personal computing device;
providing said high definition content feed to a networked distribution device; and
streaming said high definition content from said networked distribution device to the networked personal computing device for rendering on a high definition display.

16. A method as recited in claim 15, wherein the computing network is an IP network.

17. A method as recited in claim 16, further comprising embedding the high definition content into other multimedia offerings.

18. A method as recited in claim 17, wherein said high definition content is a high definition video.

19. A method as recited in claim 17, wherein said high definition content is a high definition image.

20. A computer readable medium having computer executable instructions for executing the method recited in claim 6.

21. A computer system having a processor, a memory and an operating environment, the computer system operable to execute the method recited in claim 6.

22. A computer readable medium having computer executable instructions for the method recited in claim 10.

23. A computer system having a processor, a memory and an operating environment, the computer system operable to execute the method recited in claim 10.

24. A method in a computer system having a graphical user interface including a display for displaying and a means for user selections in the computer system, said method comprising:
displaying an image comprising:
a high definition image;
a video image; and
a browser page.
displaying a navigation menu; and
displaying a URL window.

25. A method as recited in claim 24 further comprising, displaying branding information.

26. A method as recited in claim 24 further comprising, displaying thumbnails for selecting said high definition image.

27. A method in a computing system for compressing digital high definition data utilizing a software program that provides a plurality of variable settings to perform compression, wherein the plurality of variable settings comprises:
image options having a Crop value and an Image size value, said Crop value associated with left, top, right and bottom values;
wherein said left value has a range of 0 to 1920, preferably a value of approximately 0;
wherein said top value has a range of 0 to 1080, preferably a value of approximately 88;
wherein said right value has a range of 0 to 1920, preferably a value of approximately 0; and
wherein said bottom value has a range of 0 to 1080, preferably a value of approximately 88;
image size dimensions with a range from 0 by 0 to 1920 by 1080, preferably a value of approximately 960 by 452;
display size option having Deinterlace, Blur and Adaptive Noise Reduce options;
said Deinterlace option, preferably set to ‘Odd with Adaptive’;
said Blur option, preferably set to ‘Mild’; and
said Adaptive Noise Reduce option, preferably set to ‘Mild’;
adjust options associated with a Gamma value and a Brightness value;
said Gamma value having a range of ______ to ______, preferably a value of approximately −15; and
said Brightness value a range of ______ to ______, preferably a value of approximately 20;
encode options associated with Codec, Bit Depth, Spatial Quality, Frame Rate and Keyframes;
said Codec is preferably set to ‘MPEG4 Compressor’;
said Bit Depth is preferably set to ‘Millions of colors’;
said Spatial Quality has a range of ______ to ______, preferably a value of approximately 65;
said Frame Rate is preferably set to ‘Same as source’; and
said keyframes is preferably set to ‘None’;
begin/end option associated with Video Fades, wherein said Video Fades has Fade in and Fade out options;
said Fade in option has a range from ______ to ______ seconds, preferably a value of approximately 0.5 seconds; and
said Fade out option has a range from ______ to ______ seconds, preferably a value of approximately 0.5 seconds.

28. A method for use in a networked computing environment for displaying high definition content from a high definition feed source feed source on a destination high definition display device, comprising:
digitizing information from said high definition feed source;
optimally compressing said digitized information; and
creating streams of said compressed information for transfer over the network to said destination high definition display device for display.

29. A method for use in a networked computing environment for providing interactive high definition multimedia content comprising;
providing means to prompt for a stream of high definition content;
receiving and Caching said high definition content from a networked distribution device; and
displaying on a high definition display said high definition content along with other content.

30. A method for combing dynamic data with high definition video content through sever-generated XML, comprising:
playlist;
thumbnails;
content descriptions; and
personalization items comprising:
branding;
names;
messages; and
favorites.
